(19) United States
(12) Patent Application Publication
(10) Pub. No.: US 2012/0086671 A1
(43) Pub. Date: Apr. 12, 2012

(54) CAPACITANCE VARIATION DETECTION CIRCUIT, AND DISPLAY DEVICE

(76) Inventors: Christopher Brown, Oxford (GB); Hiromi Katoh, Osaka-shi (JP); Kohei Tanaka, Osaka-shi (JP)

(21) Appl. No.: 13/378,934

(22) PCT Filed: Jun. 11, 2010
(86) PCT No.: PCT/JP2010/059965

§ 371 Date: Dec. 16, 2011

(30) Foreign Application Priority Data
Jun. 19, 2009 (JP) 2009-146530

(51) Int. Cl. G06F 3/045

(52) U.S. Cl. 345/174

(57) ABSTRACT

A capacitance variation detection circuit is provided in which detection sensitivity to variations in the liquid crystal capacitance can be improved. A capacitance variation detection circuit (10) includes a first variable capacitance portion (C_{LC1}) connected to the voltage supply line; a second variable capacitance portion (C_{LC2}) connected in series with the first variable capacitance portion (C_{LC1}); and a TFT (15) connected to the second variable capacitance portion (C_{LC2}) to be driven depending on the capacitance value of the first variable capacitance (C_{LC1}) and the capacitance value of the second variable capacitance (C_{LC2}), to output an electrical signal corresponding to these capacitance values.

### REFERENCE TO RELATED APPLICATIONS

This application is a national stage application under 35 USC 371 of International Application No. PCT/JP2010/059965, filed Jun. 11, 2010, which claims the priority of Japanese Patent Application No. 2009-146530, filed Jun. 19, 2009, the contents of both of which prior applications are incorporated herein by reference.

### FIELD OF THE INVENTION

The present invention relates to a capacitance variation detection circuit, and a display device.

### BACKGROUND OF THE INVENTION

A touch panel allows a user to use the tip of his finger or a pen to write characters or draw pictures on the screen, or select an icon on the screen to cause a machine, such as a computer, to execute an instruction. A display device including a touch panel is capable of determining whether or not the tip of the user's finger or the pen is in contact with the screen and, if so, where.

In such a touch panel, a technique to detect a contact with improved reliability in any environment involves detecting capacitance variations in a cell caused by the pressure following the contact. A method of detecting a capacitance variation in a cell may involve detecting a variation in the distance between the electrode on the counter-substrate and the electrode on the TFT substrate in a liquid crystal display device, i.e. a variation in the liquid crystal capacitance (see, for example, JP-Hei9(1997)80467A and JP2006-40289A). These documents each disclose a capacitance variation detection circuit including a variable capacitance in which the electrostatic capacitance varies in response to a contact, and a device (or a circuit) for detecting such a capacitance variation in the variable capacitance.

### SUMMARY OF THE INVENTION

However, in a conventional capacitance variation detection circuit, a liquid crystal capacitance must be formed in a small gap such that the capacitance varies significantly following small pressures, in order to improve detection sensitivity to variations in the liquid crystal capacitance. As such, controlling manufacturing processes for liquid crystal display devices is difficult. Moreover, if the sizing of the gap is restricted for manufacturing process reasons, circuit parameters are in a limited range, making optimization of the circuit difficult. Furthermore, an arrangement including a sub-photo spacer, as is the case with the above implementation, requires an additional process for providing the sub-photo spacer, leading to greater costs.

An object of the present invention is to provide a capacitance variation detection circuit in which detection sensitivity to capacitance variations in a cell can be improved in an easy way.

A capacitance variation detection circuit according to an embodiment of the present invention is capacitance variation detection circuit for detecting a variation in capacitance in a cell, including: a first variable capacitance portion connected to a voltage supply line; a second variable capacitance portion connected in series with the first variable capacitance portion; and a switching device connected to the second variable capacitance portion, the switching device being driven depending on a capacitance value of the first variable capacitance portion and a capacitance value of the second variable capacitance portion, to output an electrical signal corresponding to these capacitance values.

According to this embodiment, variable capacitance portions are connected in series to provide a capacitance variation detection circuit in which detection sensitivity to variations in the liquid crystal capacitance can be improved.

### BRIEF DESCRIPTION OF THE DRAWINGS

FIG. 1 is a block diagram depicting a liquid crystal display device including a capacitance variation detection circuit according to an embodiment of the present invention.

FIG. 2 is a circuit diagram depicting the capacitance variation detection circuit according to the embodiment of the present invention.

FIG. 3 is a cross sectional view of the capacitance variation detection circuit according to the embodiment of the present invention.

FIG. 4 is a plan view of the capacitance variation detection circuit according to the embodiment of the present invention.

FIG. 5 is a circuit diagram depicting a capacitance variation detection circuit according to Conventional Implementation 1.

FIG. 6 is a cross sectional view of the capacitance variation detection circuit according to Conventional Implementation 1.

FIG. 7 is a circuit diagram depicting a capacitance variation detection circuit according to Conventional Implementation 2.

FIG. 8 is a cross sectional view of the capacitance variation detection circuit according to Conventional Implementation 2.

FIG. 9 is a cross sectional view of a capacitance variation detection circuit according to another embodiment of the present invention including a sub-photo spacer.

### DETAILED DESCRIPTION OF THE INVENTION

A capacitance variation detection circuit according to an embodiment of the present invention is a capacitance variation detection circuit for detecting a variation in capacitance in a cell, including: a first variable capacitance portion connected to a voltage supply line; a second variable capacitance portion connected in series with the first variable capacitance portion; and a switching device connected to the second variable capacitance portion, the switching device being driven depending on a capacitance value of the first variable capacitance portion and a capacitance value of the second variable capacitance portion, to output an electrical signal corresponding to these capacitance values (first arrangement).

According to the above arrangement, variable capacitance portions are connected in series, such that variations in the liquid crystal capacitance can be detected with improved sensitivity based on variations in the variable capacitance portions. This provides a capacitance variation detection circuit in which detection sensitivity to variations in the liquid crystal capacitance can be improved in an easy way.

In the first arrangement, it is preferable that a first substrate and a second substrate opposite the first substrate are included, wherein: the first substrate includes a floating electrode; the second substrate includes a first electrode and a second electrode; the first variable capacitance portion is formed between the first electrode and the floating electrode; and the second variable capacitance portion is formed between the second electrode and the floating electrode (second arrangement).

Thus, two variable capacitance portion and second variable capacitance portion connected in series are formed between the first and second substrates. Moreover, the above arrangement enables detecting variations at the first and the second variable capacitance portions based on variations at the gap between the first and second substrates, thereby enabling detecting variations in the liquid crystal capacitance with improved sensitivity.

A display device according to an embodiment of the present invention is a display device for detecting a contact location in a display screen based on a variation in capacitance between an electrode on a first substrate and an electrode on a second substrate, including: a plurality of pixel circuits; at least one capacitance variation detection circuit; and an active matrix substrate, wherein the capacitance variation detection circuit includes: a first variable capacitance portion connected to a voltage supply line; a second variable capacitance portion connected in series with the first variable capacitance portion; and a switching device connected to the second variable capacitance portion, the switching device being driven depending on a capacitance value of the first variable capacitance portion and a capacitance value of the second variable capacitance portion, to output an electrical signal corresponding to these capacitance values (third arrangement).

Thus, a display device can be provided in which detection sensitivity to variations in capacitance in a cell can be improved in an easy way where circuit parameters of the capacitance variation detection circuit are not restricted.

In the third arrangement, it is preferable that: the first substrate includes a floating electrode; the second substrate includes a first electrode and a second electrode; the first variable capacitance portion is formed between the first electrode and the floating electrode; and the second variable capacitance portion is formed between the second electrode and the floating electrode (fourth arrangement).

Thus, a display device that provides advantages similar to those of the second arrangement can be achieved.

In the fourth arrangement, it is preferable that: on the first substrate is formed a projection that projects toward the second substrate; the floating electrode is formed to cover the projection; and the first electrode and the second electrode are provided opposite the projection (fifth arrangement).

Thus, in an arrangement including a projection, the first and second variable capacitance portions are formed between a floating electrode covering the projection and the first and second electrodes, respectively, thereby further improving detection sensitivity to variations in capacitance in a cell.

### Embodiment

Now, a liquid crystal display device including a capacitance variation detection circuit according to an embodiment will be described in detail referring to the drawings.

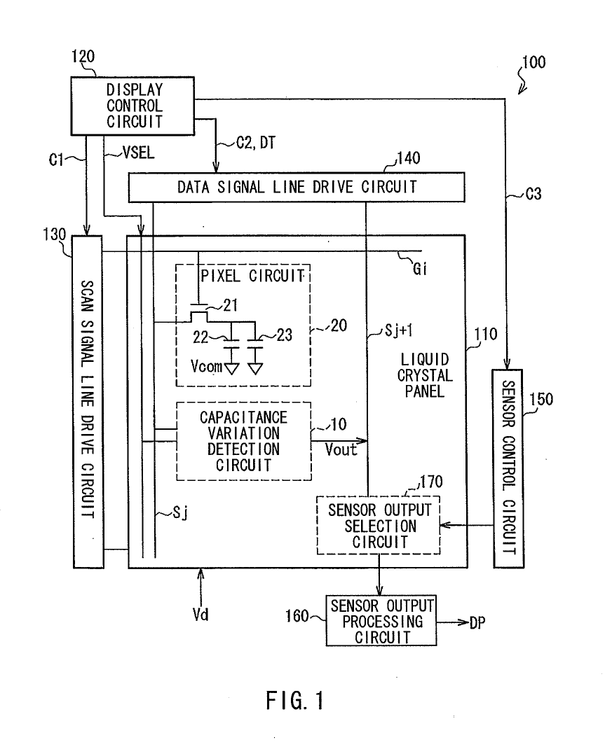

FIG. 1 is a block diagram depicting a liquid crystal display device 100 including a capacitance variation detection circuit according to an embodiment. The liquid crystal display device 100 is a liquid crystal display device including touch sensor functionality. In FIG. 1, the liquid crystal display device 100 includes a liquid crystal panel 110, a display control circuit 120, a scan signal line drive circuit 130, a data signal line drive circuit 140, a sensor control circuit 150 and a sensor output processing circuit 160. Capacitance variation detection circuits 10 are formed, together with pixel circuits 20, on the liquid crystal panel 110 and are capable of detecting variations in electrostatic capacitance in the liquid crystal layer occurring when the surface of the liquid crystal panel 110 is depressed.

The liquid crystal panel 110 has a liquid crystal material sandwiched between two resin substrates. The liquid crystal panel 110 includes a plurality of scan signal lines Gi parallel to each other and a plurality of data signal lines Sj perpendicular to the scan signal lines Gi and parallel to each other. A pixel circuit 20 is provided in the vicinity of the intersection of a scan signal line Gi and a data signal line Sj. A scan signal line Gi is connected to the pixel circuits 20 disposed in the same row. A data signal line Sj is connected to the pixel circuits 20 disposed in the same column. A capacitance variation detection circuit 10 is provided for a pixel circuit 20. Note that it is not necessary that a capacitance variation detection circuit 10 corresponds to a single pixel circuit 20. Further, in a liquid crystal panel 110, a sensor output selection circuit 170 is provided for selecting at least one signal from output signals from the capacitance variation detection circuits 10.

A pixel circuit 20 includes a TFT 21, a liquid crystal capacitance 22 and an auxiliary capacitance 23. The TFT 21 may be an n-channel MOS transistor, for example. The TFT 21 has a gate electrode connected to one scan signal line Gi, a source electrode connected to one data signal line Sj and a drain electrode connected to one of the two electrodes constituting the liquid crystal capacitance 22 and one of the two electrodes constituting the auxiliary capacitance 23. The other one of the electrodes constituting the liquid crystal capacitance 22 and the other one of the electrodes constituting the auxiliary capacitance 23 are connected to a voltage supply line (not shown), to which a common voltage V_{com} is applied.

The display control circuit 120, the scan signal line drive circuit 130, the data signal line drive circuit 140 and the sensor control circuit 150 are control circuits for the liquid crystal panel 110. The display control circuit 120 outputs a control signal C1 to the scan signal line drive circuit 130, and outputs a control signal C2 and a video signal DT to the data signal line drive circuit 140. The display control circuit 120 outputs a control signal C3 to the sensor control circuit 150 and supplies a capacitance variation detection circuit 10 of the liquid crystal panel 110 with a control voltage VSEL via a line VSEL.

The scan signal line drive circuit 130 selects one scan signal line from a plurality of scan signal lines Gi based on the control signal C1 and applies a gate-on voltage (the voltage that turns a TFT on) to the selected scan signal line. The data signal line drive circuit 140 applies to a data signal line Sj a voltage corresponding to the video signal DT in accordance with the control signal C2. Thus, one row of pixel circuits 20 is selected and a voltage corresponding to the video signal DT is applied to the selected pixel circuits 20 and the desired image can be displayed on the liquid crystal panel 110.

The sensor control circuit 150 controls the sensor output selection circuit 170 in accordance with the control signal C3. The sensor output selection circuit 170 selects at least one signal from output signals from a plurality of capacitance variation detection circuits 10 based on the output signal from the sensor control circuit 150. Thereafter, the sensor output selection circuit 170 outputs the selected signal to outside the liquid crystal panel 110. Based on this signal output from the liquid crystal panel 110, the sensor output processing circuit 160 obtains position data DP that indicates a contact location in the display screen.

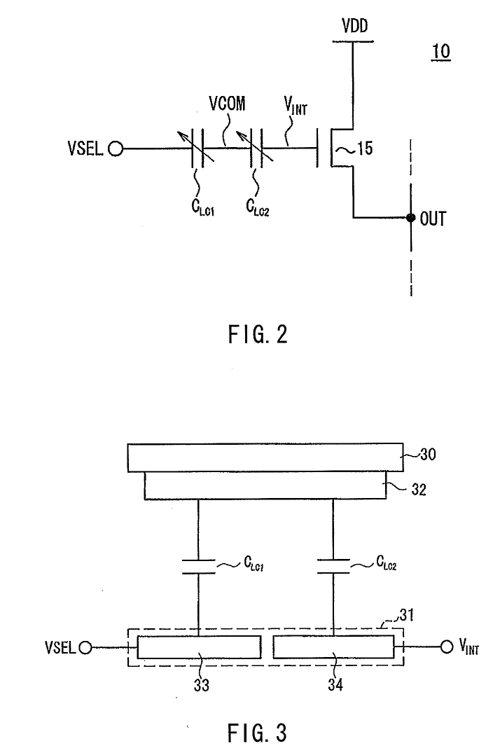

FIG. 2 is a circuit diagram of the capacitance variation detection circuit 10 according to the embodiment. As shown in FIG. 2, the capacitance variation detection circuit 10 includes a first variable capacitance portion C_{LC1} connected to the voltage supply line VSEL and a second variable capacitance portion C_{LC2} connected in series with the first variable capacitance portion C_{LC1}. The capacitance variation detection circuit 10 includes a TFT 15, having a gate electrode connected to the one of the pair of electrodes constituting the second variable capacitance portion C_{LC2} that is other than the one connected to the first variable capacitance portion C_{LC1}. The TFT 15 is driven based on the capacitance values of the first variable capacitance portion C_{LC1} and the second variable capacitance portion C_{LC2} and outputs an electrical signal corresponding to these capacitance values. The TFT 15 serves as a switching device for outputting an electrical signal corresponding to the capacitance values of the first variable capacitance portion C_{LC1} and the second variable capacitance portion C_{LC2}.

As shown in FIG. 3, the capacitance variation detection circuit 10 according to the present embodiment includes a counter-substrate 30 and an active matrix substrate 31 opposite the counter-substrate 30. The counter-substrate 30 includes a common electrode, not shown, and an island-shaped floating electrode 32 made of the same metal as the common electrode (for example, ITO). The floating electrode 32 is constructed by, for example, etching a portion of the metal film constituting the common electrode to form an island. The floating electrode 32 is electrically separate from the common electrode, i.e. in a floating state. The active matrix substrate 31 includes a first electrode 33 and a second electrode 34. The first electrode 33 and the second electrode 34 are made of the same metal material as the pixel electrode, such as ITO, and are formed by the same process as the pixel electrode.

The first electrode 33 is one of the pair of electrodes establishing the first variable capacitance portion C_{LC1}. The floating electrode 32 is the other one of the pair of electrodes establishing the first variable capacitance portion C_{LC1} and is also one of the pair of electrodes establishing the second variable capacitance portion C_{LC2}. The second electrode 34 is the other one of the pair of electrodes establishing the second variable capacitance portion C_{LC2}. The first electrode 33 and the second electrode 34 are disposed opposite the floating electrode 32. In this way, the first variable capacitance portion C_{LC1} and the second variable capacitance portion C_{LC2} are connected in series.

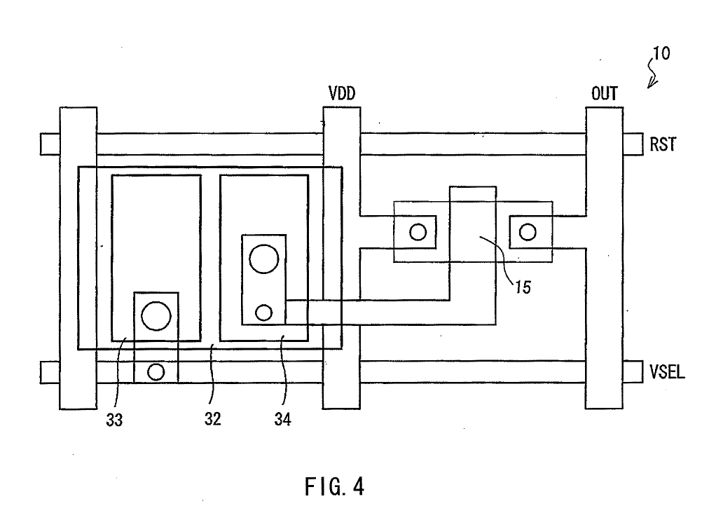

FIG. 4 shows a specific implementation of the capacitance variation detection circuit 10. In the capacitance variation detection circuit 10, the TFT 15 has a source electrode connected to the line VDD and a drain electrode connected to the line OUT. The TFT 15 has a gate electrode connected to the second electrode 34 that establishes the second variable capacitance portion C_{LC2}. The first electrode 33 that establishes the first variable capacitance portion C_{LC1} is connected to the line VSEL. The floating electrode 32 is electrically separate from the other electrodes, lines and other components. As discussed above, the first variable capacitance portion C_{LC1} is formed between the floating electrode 32 and the first electrode 33, while the second variable capacitance portion C_{LC2} is formed between the floating electrode 32 and the second electrode 34.

The capacitances of the first variable capacitance portion C_{LC1} and the second variable capacitance portion C_{LC2} vary depending on the distances between the floating electrode 32 and the first and second electrodes 33 and 34. Accordingly, when the counter-substrate 30 is depressed and the distances between the floating electrode 32 and first and second electrodes 33 and 34 vary, the capacitances of the first variable capacitance portion C_{LC1} and the second variable capacitance portion C_{LC2} vary. When V_{SEL} goes to high level (ON), the TFT 15 becomes conductive and an output signal corresponding to the potential on V_{INT} is output to the line OUT. In the capacitance variation detection circuit 10 according to the present embodiment, the value of the voltage V_{INT} which is dependent on the capacitance values of the first variable capacitance portion C_{LC1} and the second variable capacitance portion C_{LC2} are calculated using (Equation 1) below. Here, since the capacitances of the first variable capacitance portion C_{LC1} and the second variable capacitance portion C_{LC2} are equal, the capacitance values of the first variable capacitance portion C_{LC1} and the second variable capacitance portion C_{LC2} are represented simply by C_{LC} in (Equation 1). Further, C_{TFT} represents the electrostatic capacitance of the TFT 15. Δ VSEL represents the amount of variation in the voltage V_{SEL} when it goes to high level.

V_{INT}=ΔV_{SEL}*0.5*C_{LC}/(0.5*C_{LC}+C_{TFT}) (Equation 1)

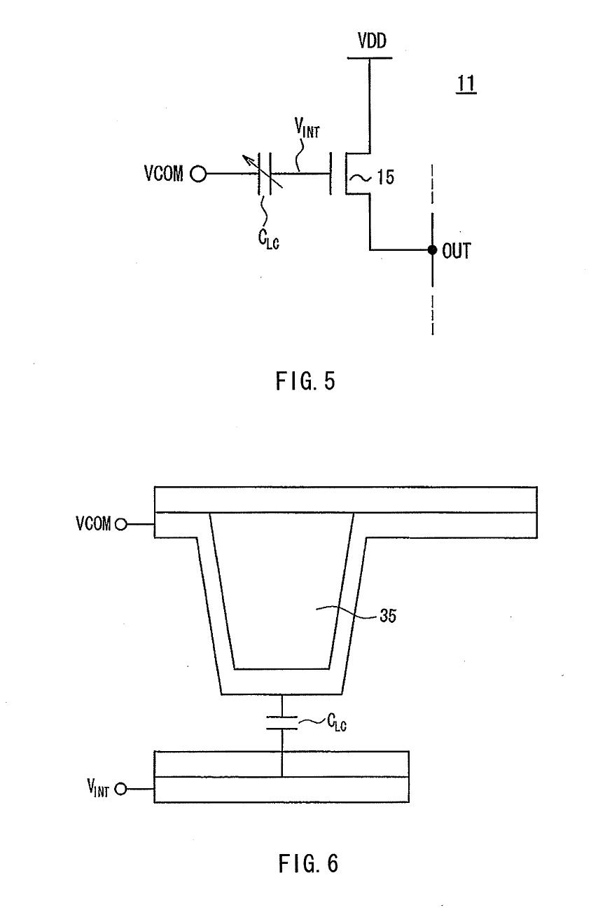

FIG. 5 is a circuit diagram of a capacitance variation detection circuit 11 according to Conventional Implementation 1. As shown in FIG. 5, the capacitance variation detection circuit 11 includes a variable capacitance portion C_{LC} and a TFT 15. In the variable capacitance portion C_{LC}, one of the pair of electrodes forming the variable capacitance portion C_{LC} is connected to a voltage supply line to which the common voltage V_{com} is applied, while the other electrode is connected to the gate electrode of the TFT 15. The TFT 15 serves as a detection transistor outputting an electrical signal corresponding to the capacitance value of the variable capacitance portion C_{LC}.

As shown in FIG. 6, a sub-photo spacer 35 is provided in the capacitance variation detection circuit 11 of Conventional Implementation 1. In the capacitance variation detection circuit 11 of Conventional Implementation 1, the value of the voltage V_{INT} which is dependent on the capacitance value of the variable capacitance portion C_{LC} can be calculated from (Equation 2) below. Here, Δ V_{com} represents the amount of variation in the voltage V_{com}.

V_{INT}=ΔV_{com}*C_{LC}/(C_{LC}+C_{TFT}) (Equation 2)

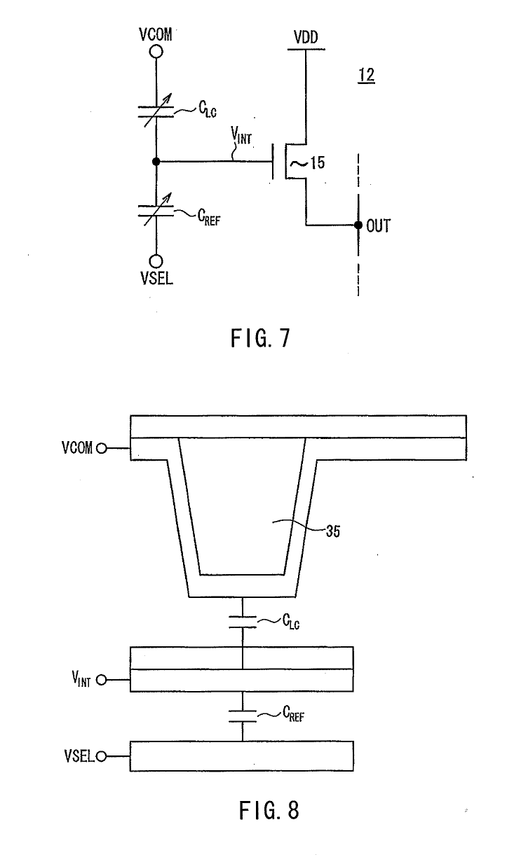

FIG. 7 is a circuit diagram of a capacitance variation detection circuit 12 according to Conventional Implementation 2. As shown in FIG. 7, the capacitance variation detection circuit 12 includes a variable capacitance portion C_{LC}, a reference capacitance portion C_{REF}, and a TFT 15. In the variable capacitance portion C_{LC}, one of the pair of electrodes forming the variable capacitance portion C_{LC} is connected to a voltage supply line of the common voltage V_{com}, while the other electrode is connected to one of the pair of electrodes forming the gate electrode of the TFT 15 and the reference capacitance portion C_{REF}. The other one of the pair of electrodes forming the reference capacitance portion C_{REF} is connected to a voltage supply line to which V_{SEL} is applied. The TFT 15 serves as a detection transistor for outputting an electrical signal corresponding to the capacitance value of the variable capacitance portion C_{LC}. As shown in FIG. 8, a sub-photo spacer 35 is provided in the capacitance variation detection circuit 12 of Conventional Implementation 2. In the capacitance variation detection circuit 12 of Conventional Implementation 2, the value of the voltage V_{INT} which is dependent on the capacitance value of the variable capacitance portion C_{LC} is calculated from (Equation 3) below.

V_{INT}=ΔV_{SEL}*C_{REF}/(C_{REF}+C_{LC}+C_{TFT}) (Equation 3)

In the capacitance variation detection circuit 11 of Conventional Implementation 1, the voltage level of V_{com} is restricted by the specs of the display and thus is small. In reality, C_{TFT} is large, such that the amount of variation in C_{LC} must be relatively large to enable detecting variations in capacitance in (Equation 2) with good sensitivity. Accordingly, a sub-photo spacer 30 must be provided to reduce the gap in which a liquid crystal capacitance is formed. Further, in the capacitance variation detection circuit 12 of Conventional Implementation 2, the variable C_{LC} is only in the denominator in (Equation 3) such that variations in V_{INT} are small, leading to a low detection sensitivity to variations in capacitance. Accordingly, a sub-photo spacer 30 must also be provided in the capacitance variation detection circuit 12 of Conventional Implementation 2. On the contrary, in the capacitance variation detection circuit 10 according to the embodiment of the present invention, the variable C_{LC} is in both the denominator and numerator as indicated in (Equation 1), such that the variation width in voltage can be determined using V_{SEL}, which can be set freely, instead of V_{com}, which is restricted by display specs. Thus, variations in V_{INT} can be increased, thereby increasing detection sensitivity to variations in capacitance. Therefore, a sub-photo spacer as in Conventional Implementations 1 and 2 is not necessary.

As described above, according to the present invention, the variable capacitance portions C_{LC1} and C_{LC2} are connected in series, such that detection sensitivity to variations in the liquid crystal capacitance can be easily improved without a sub-photo spacer. Further, detection sensitivity to variations in the liquid crystal capacitance can be adjusted using V_{SEL}, which can be set freely. Furthermore, a signal is output from the TFT 15 only when V_{SEL} is at high level (ON), such that source lines can be shared.

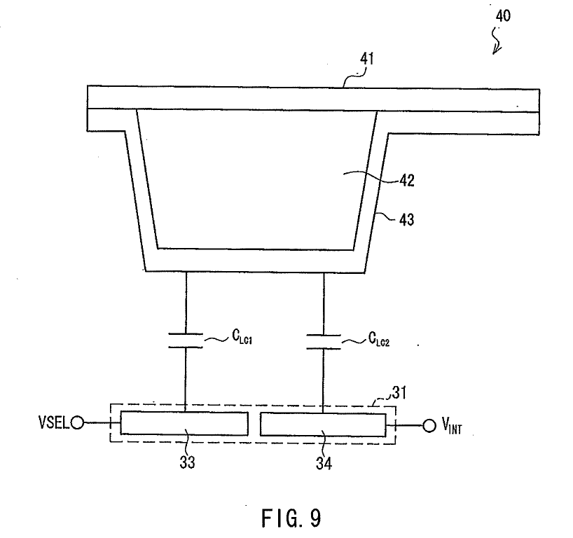

It should be noted that, as shown in FIG. 9, a sub-photo spacer 42 as a projection may also be provided on the counter-substrate 41. Specifically, a capacitance variation detection circuit 40 includes a counter-substrate 41 and an active matrix substrate 31 opposite the counter-substrate 41. A sub-photo spacer 42 is formed on the counter-substrate 41, and a floating electrode 43 is provided on the sub-photo spacer 42. The floating electrode 43 is electrically separate from other electrodes and other components and thus is in a floating state. The active matrix substrate 31 is disposed opposite the counter-substrate 41 having a sub-photo spacer 42, and includes a first electrode 33 and a second electrode 44.

The first electrode 33 is one of the pair of electrodes establishing the first variable capacitance portion C_{LC1}. The floating electrode 43 is the other one of the pair of electrodes establishing the first variation capacitance portion C_{LC1} and is also one of the pair of electrodes establishing the second variable capacitance portion C_{LC2}. The second electrode 34 is the other one of the pair of electrodes establishing the second variable capacitance portion C_{LC2}. The first electrode 33 and the second electrode 34 are disposed opposite the floating electrode 43. In this way, the first variable capacitance portion C_{LC1} and the second variable capacitance portion C_{LC2} are connected in series. The capacitances of the first variable capacitance portion C_{LC1} and the second variable capacitance portion C_{LC2} vary depending on the distances between the floating electrode 43 and the first and second electrodes 33 and 34. Accordingly, when the counter-substrate 41 is depressed and the distances between the floating electrode 43 and the first and second electrodes 33 and 34 vary, the capacitances of the first variable capacitance portion C_{LC1} and the second variable capacitance portion C_{LC2} vary. When V_{SEL} goes to high level (ON), the TFT 15 becomes conductive, such that an output signal corresponding to the potential on V_{INT} is output to the line OUT. Thus, a higher sensitivity of the touch sensor can be achieved compared with conventional arrangements that simply use a sub-photo spacer. Moreover, changing the size of the sub-photo spacer changes the gap between the floating electrode 43 and the first and second electrodes 33 and 34, thereby optimizing circuit parameters of the capacitance variation detection circuit 40.

The present invention may also be employed in display devices other than liquid crystal display devices. Further, it can also be used in a mere touch sensor.

The arrangements described in the above embodiments merely illustrate specific examples and are not intended to limit the technical scope of the present invention. Any arrangement that achieves the advantages of the present invention may be employed.

1. A capacitance variation detection circuit for detecting a variation in capacitance in a cell, comprising:
a first variable capacitance portion connected to a voltage supply line;
a second variable capacitance portion connected in series with the first variable capacitance portion; and
a switching device connected to the second variable capacitance portion, the switching device being driven depending on a capacitance value of the first variable capacitance portion and a capacitance value of the second variable capacitance portion, to output an electrical signal corresponding to these capacitance values.

2. The capacitance variation detection circuit according to claim 1, further comprising:
a first substrate; and
a second substrate opposite the first substrate,
wherein:
the first substrate includes a floating electrode;
the second substrate includes a first electrode and a second electrode;
the first variable capacitance portion is formed between the first electrode and the floating electrode; and
the second variable capacitance portion is formed between the second electrode and the floating electrode.

3. A display device for detecting a contact location in a display screen based on a variation in capacitance between an electrode on a first substrate and an electrode on a second substrate, comprising:
a plurality of pixel circuits;
at least one capacitance variation detection circuit; and
an active matrix substrate,
wherein the capacitance variation detection circuit includes:
a first variable capacitance portion connected to a voltage supply line;
a second variable capacitance portion connected in series with the first variable capacitance portion; and
a switching device connected to the second variable capacitance portion, the switching device being driven depending on a capacitance value of the first variable capacitance portion and a capacitance value of the second variable capacitance portion, to output an electrical signal corresponding to these capacitance values.

4. The display device according to claim 3, wherein:
the first substrate includes a floating electrode;
the second substrate includes a first electrode and a second electrode;
the first variable capacitance portion is formed between the first electrode and the floating electrode; and
the second variable capacitance portion is formed between the second electrode and the floating electrode.

5. The display device according to claim 4, wherein:
on the first substrate is formed a projection that projects toward the second substrate;
the floating electrode is formed to cover the projection; and
the first electrode and the second electrode are provided opposite the projection.
